(19) United States
(12) Patent Application Publication
(10) Pub. No.: US 2026/0257741 A1
(43) Pub. Date: Sep. 3, 2026

(54) Motorcycle, and Method for Operating a Holding Device of a Headlight of a Motorcycle

(71) Applicant: Bayerische Motoren Werke Aktiengesellschaft, Muenchen (DE)

(72) Inventor: Steffen RAU, Baar-Ebenhausen (DE)

(21) Appl. No.: 18/881,843

(22) PCT Filed: Aug. 9, 2023
(86) PCT No.: PCT/EP2023/072002

§ 371 Date: Jan. 7, 2025

(30) Foreign Application Priority Data
Aug. 25, 2022 (DE) 10 2022 121 525.3

(51) Int. Cl. B62J 6/023; B62J 6/025; B62J 6/027

(52) U.S. Cl. CPC B62J 6/023; B62J 6/025; B62J 6/027

(57) ABSTRACT

A motorcycle comprising at least one headlight, which is designed to illuminate at least one part region of a surrounding area of the motorcycle, and is held on a chassis of the motorcycle via a gimballed mount of a holding device which has a drive device. The gimballed mount permits pivoting movements of the headlight which take place about at least two pivot axes, running perpendicularly with respect to one another, and relative to the chassis. The drive device is designed to provide a force and/or a torque and to exert them/it on the gimballed mount, in order to counteract the respective pivoting movement running about the respective pivoting axis as a result, and in order to brake the respective pivoting movement as a result.

### BACKGROUND AND SUMMARY

This disclosure relates to a motorcycle, and to a method for operating a holding device of a headlight of a motorcycle.

A device for independently correcting an alignment of a headlight bundle of a motor vehicle can be inferred as known from DE 37 43 137 C2. Furthermore, DE 198 17 594 C2 discloses a headlight stabilizer system. Moreover, a holding device for a headlight is known from DE 10 2019 123 312 B3.

An object of the present disclosure is to provide a motorcycle and a method for operating a holding device of a motorcycle, so that particularly advantageous operation of the motorcycle can be implemented.

A first aspect of the disclosure relates to a motorcycle, which can be designed in particular as a motorbike. The motorcycle has a headlight, by way of which at least a section of the surroundings of the motorcycle can be illuminated. This means that the headlight can provide light and radiate it into or onto the surroundings, in order to thus illuminate at least a section of the surroundings. The headlight is held on a chassis of the motorcycle, also referred to as a frame or designed as a frame, via a gimbal mount of a holding device of the motorcycle. The holding device comprises a drive device and the gimbal mount. The gimbal mount permits pivot movements of the headlight which take place around at least or precisely two pivot axes extending perpendicularly to one another and relative to the chassis. In other words, because the headlight is held on the chassis via the gimbal mount, the headlight is pivotable relative to the chassis both around a first of the pivot axes and around a second of the pivot axes, wherein the pivot axes extend perpendicularly to one another. This means that the headlight can execute first ones of the pivot movements relative to the chassis around the first pivot axis, and the headlight can execute second ones of the pivot movements relative to the chassis around the second pivot axis. In still other words, the headlight is rotationally movable, i.e. rotatable, both around the first pivot axis and around the second pivot axis. For example, the first pivot axis extends in the vehicle longitudinal direction of the motorcycle, also referred to as a vehicle, therefore parallel to the vehicle longitudinal direction of the motorcycle, or the first pivot axis extends, for example, in the vehicle transverse direction of the motorcycle, therefore parallel to the vehicle transverse direction of the motorcycle, or the first pivot axis extends in the vehicle vertical direction of the motorcycle, therefore parallel to the vehicle vertical direction. The vehicle longitudinal direction is also referred to with x or as the x direction, wherein the vehicle transverse direction is also referred to with y or as the y direction, and wherein the vehicle vertical direction is also referred to with z or as the z direction. The second pivot axis extends, for example, in the vehicle transverse direction, therefore parallel to the vehicle transverse direction, or in the vehicle vertical direction, therefore parallel to the vehicle vertical direction, in particular if the first pivot axis extends in the vehicle longitudinal direction or parallel to the vehicle longitudinal direction. The second pivot axis extends, for example, in the vehicle longitudinal direction, therefore parallel to the vehicle longitudinal direction or in the vehicle vertical direction or parallel to the vehicle vertical direction, in particular if the first pivot axis extends in the vehicle transverse direction or parallel to the vehicle transverse direction. For example, the second pivot axis extends in the vehicle longitudinal direction or parallel to the vehicle longitudinal direction or in the vehicle transverse direction or parallel to the vehicle transverse direction, in particular if the first pivot axis extends in the vehicle vertical direction or parallel to the vehicle vertical direction.

Pitching movements taking place around the vehicle transverse direction and rolling movements of the motorcycle taking place around the vehicle longitudinal direction can be compensated for by the gimbal mount, for example, or pitching movements and yawing movements of the motorcycle taking place around the vehicle vertical direction can be compensated for by way of the gimbal mount, or, for example, rolling movements and yawing movements of the motorcycle can be compensated for by way of the gimbal mount. This is to be understood in particular to mean that, for example, when the chassis executes a pitching movement and/or a rolling movement and/or a yawing movement starting from a respective starting orientation of the chassis and the headlight and is therefore moved out of the starting orientation of the chassis, the headlight maintains its starting orientation or is only moved slightly, i.e. less out of the starting orientation of the headlight than the chassis is moved out of the starting orientation of the chassis. Due to the gimbal mount, the headlight therefore does not also execute pitching and/or rolling and/or yawing movement of the chassis or only executes it slightly or less strongly than the chassis, so that, in spite of the pitching and/or rolling and/or yawing movement, the surroundings can still be illuminated particularly advantageously by way of the headlight. Especially safer and therefore more advantageous operation of the motorcycle can thus be ensured.

To now be able to implement particularly advantageous, in particular particularly safe operation of the motorcycle, the drive device is designed to provide a force and/or a torque and to exert it on the gimbal mount, in order to thus counteract the respective pivot movement of the headlight, designed as a front headlight, for example, extending around the respective pivot axis and thus to decelerate the respective pivot movement. Excessive overshooting can be prevented in this way. This is in particular to be understood as follows. If the chassis executes a movement, for example, such that the chassis is moved out of the starting orientation of the chassis, a pivot movement of the headlight takes place around at least one of the pivot axes relative to the chassis, in particular such that the headlight, although the chassis is moved out of the starting orientation of the chassis, remains in the starting orientation of the headlight or is moved less strongly out of the starting orientation of the headlight then the chassis is moved out of the starting orientation of the chassis. The above-mentioned movement of the chassis is thus so to speak compensated for or balanced out. The gimbal mount and the headlight held thereon form, for example, a system or are part of a system which levels itself, i.e. aligns or holds itself, independently or automatically, in its center of gravity, in particular at all times, due to the gimbal mount, and does so preferably only with the effect of gravity. A light cone provided by the headlight for at least partially illuminating the surroundings thus remains, for example, at least stable, although the chassis moves out of its starting orientation. The chassis moves, for example, out of the starting orientation of the chassis because the motorcycle is accelerated or decelerated during a journey of the motorcycle or executes cornering and is therefore laid into a curve by the driver of the motorcycle or the chassis executes a yawing movement. For example, a pitching movement of the motorcycle, in particular of the chassis, occurs due to acceleration and deceleration of the motorcycle. Therefore, the headlight executes the pivot movement relative to the chassis in a movement direction during its respective pivot movement, in particular with respect to a predefined or predefinable reference system. Since the drive device is now designed to provide the mentioned force and/or the mentioned torque and to exert it on the gimbal mount and in this way to counteract the respective pivot movement, which extends in particular in the movement direction, it is possible to prevent the headlight from moving excessively far in the movement direction. It is therefore possible to prevent the headlight from departing from its starting orientation excessively when the chassis is moved out of its starting orientation. The drive device and the gimbal mount form a gimbal, also referred to as a gimbal system, by which undesired and excessive movements of the headlight can be prevented when the chassis is in particular moved out of its starting orientation. In this way, an advantageous distribution of the light that can be provided or is provided by the headlight and is intended to illuminate at least the section can be ensured both in the starting orientation of the chassis and in locations of the chassis different from the starting orientation of the chassis, so that particularly safe and advantageous operation can be ensured. In particular, it is possible to implement, by way of the gimbal system, that the above-mentioned system made up of the gimbal mount and the headlight held thereon remains or is leveled in its center of gravity, in particular at all times, in spite of the fact that and while, for example, the chassis is moved out of its starting orientation.

For example, the motorcycle has at least or precisely one inertial measurement unit, or the motorcycle has, for example, multiple inertial measurement units. The respective inertial measurement unit is also designated as an IMU. The respective inertial measurement unit can acquire, for example, at least one measured variable describing a respective alignment or location of the chassis, in particular around the vehicle vertical direction and/or the vehicle longitudinal direction and/or the vehicle transverse direction. For example, the respective inertial measurement unit can provide a respective, in particular electrical measurement signal which describes, i.e. characterizes, the respective variable acquired by way of the respective inertial measurement unit, in particular at least one value of the respective measured variable acquired by way of the respective inertial measurement unit. It is conceivable in particular here that the drive device is actuated and therefore operated, in particular controlled or regulated, in dependence on the signal and therefore in dependence on the measured variable acquired by way of the respective inertial measurement unit, in particular in order to thus provide the force or the torque and to exert it on the gimbal mount and therefore to counteract the respective pivot movement, therefore to decelerate the respective pivot movement. In this way, for example, the center of gravity of the system and/or the center of gravity of the headlight can always be held in or at the same position, while and although the chassis is moved and is thus moved out of the starting orientation of the chassis.

A second aspect of the disclosure relates to a motorcycle, having at least one headlight, which is designed to illuminate at least a section of the surroundings of a motorcycle and is held on a chassis of the motorcycle via a holding device, which has a drive device and a gimbal mount, which permits pivot movements of the headlight taking place around at least two pivot axes, which extend perpendicularly to one another and relative to the chassis.

To now enable particularly safe and therefore advantageous operation of the motorcycle, it is provided in the second aspect of the disclosure that the motorcycle has at least one surroundings camera, which is designed to acquire at least one area of the surroundings and is held on the chassis via the holding device, and is thus also pivotable around the pivot axes relative to the chassis with the headlight. The gimbal mount therefore has a double function. On the one hand, the gimbal mount is used to hold the headlight on the chassis and therefore to compensate for movements of the chassis or the motorcycle with regard to an alignment or location of the headlight, such that the headlight remains, in particular at all times, in its starting orientation, although and while, for example, the chassis is moved out of its starting orientation. On the other hand, the gimbal mount is used at the same time in order to also prevent, with regard to the surroundings camera, that the surroundings camera also moves excessively with the chassis. Therefore, both the headlight and the surroundings camera, which is also referred to simply as the camera, always remain in their starting orientations in spite of any movements of the chassis. Therefore, at least the section of the surroundings can advantageously be illuminated by way of the headlight, and therefore the area of the surroundings can particularly advantageously be acquired by way of the camera. Especially safe and therefore advantageous operation of the motorcycle can thus be ensured. Advantages and advantageous embodiments of the first aspect of the disclosure are to be considered advantages and advantageous embodiments of the second aspect of the disclosure and vice versa.

To be able to implement particularly safe and therefore advantageous operation of the motorcycle, it is provided in one embodiment of the second aspect of the disclosure that the drive device is designed to provide a force and/or a torque and to exert it on the gimbal mount, in order to thus counteract the respective pivot movement of the headlight and the surroundings camera extending around the respective pivot axis and thus to decelerate the respective pivot movement.

A further embodiment of the second aspect of the disclosure is distinguished in that the surroundings camera is held on the headlight and is thus held on the gimbal mount via the headlight, i.e. is coupled to the gimbal mount. It is thus possible to implement in a particularly space-saving, weight-saving, and cost-effective manner that both the headlight and the surroundings camera always remain in their starting orientations, in particular even if the chassis is moved out of its starting orientation, for example, by pitching and/or rolling and/or yawing movements.

In a further, particularly advantageous embodiment of the first aspect and the second aspect of the disclosure, it is provided that the gimbal mount also permits a pivot movement of the headlight taking place around a third pivot axis extending perpendicularly to the pivot axes and relative to the chassis. Therefore, for example, a first of the pivot axes extends in the vehicle longitudinal direction, a second of the pivot axes extends in the vehicle transverse direction, and a third of the pivot axes extends in the vehicle vertical direction, wherein the pivot axes extend perpendicularly to one another in pairs. In this way, both pitching movements and also rolling movements as well as additionally yawing movements of the chassis can be compensated for by way of the gimbal mount, so that the headlight and therefore, for example, also the surroundings camera remain in their starting orientations in spite of any pitching and/or yawing and/or rolling movements of the chassis. Particularly safe and therefore advantageous operation of the motorcycle can thus be ensured.

It has proven to be particularly advantageous here if the drive device is also designed to counteract the respective pivot movement extending around the third pivot axis by exerting the force and/or the torque on the gimbal mount and thus to decelerate the respective pivot movement extending around the third pivot axis. Excessive overshooting around the three pivot axes can thus be prevented, so that particularly advantageous operation can be represented.

To be able to implement particularly safe operation, it is provided in a further embodiment of the disclosure that the headlight is designed as a front headlight.

In a further, particularly advantageous embodiment of the disclosure, the motorcycle is a single-track vehicle having precisely two vehicle wheels, so that the motorcycle is preferably a single-track motorbike having precisely two vehicle wheels. One of the vehicle wheels is a front wheel and the other vehicle wheel is a rear wheel, which is arranged behind the front wheel in the vehicle longitudinal direction. The vehicle wheels are ground contact elements which are held rotatably on the chassis. The motorcycle is supportable or supported on the ground downward in the vehicle vertical direction via the ground contact elements. If the motorcycle is driven along the ground, while the motorcycle is supported downward via the ground contact elements on the ground in the vehicle vertical direction of the motorcycle, the vehicle wheels thus roll, in particular directly, on the ground.

Finally, it has been shown to be particularly advantageous if the motorcycle is a three-wheeled vehicle having precisely three vehicle wheels, so that the motorcycle is a tricycle, for example. Furthermore, it is conceivable that the motorcycle is a motorbike with sidecar.

A third aspect of the disclosure relates to a method for operating a holding device of a motor vehicle, in particular according to the first aspect of the disclosure. In the method according to the third aspect of the disclosure, the motorcycle has at least one headlight, which is designed to illuminate at least a section of the surroundings of the motorcycle and is held on a chassis of the motorcycle via a holding device of the motorcycle. The holding device comprises a drive device and a gimbal mount, which permits pivot movements of the headlight taking place around at least two pivot axes extending perpendicularly to one another and relative to the chassis.

In order to be able to implement particularly safe and therefore particularly advantageous operation of the motorcycle, it is provided in the third aspect of the disclosure that a force and/or a torque is provided by way of the drive device and exerted on the gimbal mount, by which the respective pivot movement extending around the respective pivot axis is counteracted and thus the respective pivot movement is decelerated.

Advantages and advantageous embodiments of the first aspect and the second aspect of the disclosure are to be viewed as advantages and advantageous embodiments of the third aspect of the disclosure and vice versa.

It is therefore provided in the disclosure that the drive device does not drive the gimbal mount or does not only drive it to compensate for movements of the chassis and to hold the headlight in its starting orientation, but rather the drive device counteracts the respective pivot movement in order to decelerate the respective pivot movement and therefore prevent overshooting around the respective pivot axis.

### BRIEF DESCRIPTION OF THE DRAWINGS

Further details of the disclosure result from the following description of preferred exemplary embodiments with the associated drawings.

FIG. 1 shows a schematic front view of a motorcycle designed as a single-track motorbike;

FIG. 2 shows a schematic front view of a headlight of the motorcycle designed as a front headlight;

FIG. 3 shows a schematic side view of the headlight;

FIG. 4 shows a further schematic front view of the headlight;

FIG. 5 shows a further schematic front view of the headlight;

FIG. 6 shows a schematic perspective view of the headlight;

FIG. 7 shows a further schematic perspective view of the headlight;

FIG. 8 shows a further schematic front view of the motorcycle; and

FIG. 9 shows a further schematic front view of the motorcycle;

FIG. 10 shows a further schematic front view of the motorcycle; and,

FIG. 11 shows a further schematic front view of the motorcycle.

In the figures, identical or functionally-identical elements are provided with identical reference signs.

### DETAILED DESCRIPTION OF THE DRAWINGS

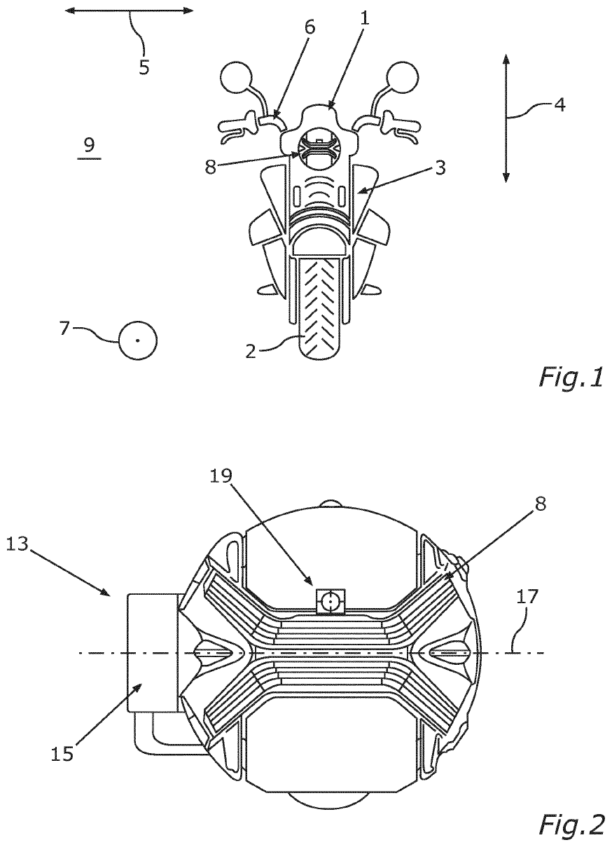

FIG. 1 shows a schematic front view of a motorcycle 1, also referred to as a vehicle, which is designed in the exemplary embodiment shown in the figures as a single-track motorbike having precisely two vehicle wheels. One of the vehicle wheels can be seen in FIG. 1 and is referred to with 2. The motorcycle 1 has a chassis 3, which is also referred to as a frame or is designed as a frame. The vehicle wheel 2 that can be seen in FIG. 1 is a front wheel of the motorcycle 1, wherein the vehicle wheel of the motorcycle 1 which cannot be seen in FIG. 1 is a rear wheel. For example, a drive motor is held on the chassis 3, by way of which drive motor, for example, at least one or precisely one of the vehicle wheels, in particular the rear wheel, is drivable in order to thus drive the motor vehicle 1 as a whole. The respective vehicle wheel of the motorcycle 1, the vehicle vertical direction of which is illustrated in FIG. 1 by a double arrow 4, is held at least indirectly on the chassis 3 so it is rotatable around a respective wheel axis of rotation relative to the chassis 3. The motorcycle 1, the vehicle transverse direction of which is illustrated by a double arrow 5, has handlebars 6, for example, which can be actuated by the driver of the motorcycle 1 and can therefore be pivoted and therefore steered together with the vehicle wheel 2 relative to the chassis 3, in order to thus, for example, be able to effectuate cornering of the motorcycle 1. The motorcycle 1, the vehicle longitudinal direction of which is illustrated by a double arrow 7 and extends perpendicularly to the image plane of FIG. 1, additionally has a headlight 8, which is designed in the exemplary embodiment shown in FIG. 1 as a front headlight. Light, in particular in the form of a light cone, can be provided by way of the headlight 8 in order to thus illuminate at least a section of the surroundings 9 of the motorcycle 1.

It can be seen from FIGS. 2 to 7 that the headlight 8 is held on the chassis 3 via a holding device 10. For this purpose, for example, the holding device 10 is attached, on the one hand, to the headlight 8, in particular to its headlight housing 11, and, on the other hand, to the chassis 3. The holding device 10 has a gimbal mount 12, via which the headlight 8 is held on the chassis 3, in particular in such a way or in that the gimbal mount 12 is attached, on the one hand, to the headlight 8, in particular to its headlight housing 11, and, on the other hand, to the chassis 3. The gimbal mount 12 permits pivot movements of the headlight 8 taking place around, in particular precisely, three pivot axes extending perpendicularly to one another and relative to the chassis 3. A first of the pivot axes extends parallel to the vehicle longitudinal direction, which is also referred to with x or as the x direction. A second of the pivot axes extends parallel to the vehicle transverse direction, which is also referred to with y or as the y direction. A third of the pivot axes extends parallel to the vehicle vertical direction, which is also referred to with z or as the z direction. In addition, the holding device 10 has a drive device 13, which in the present case has at least or precisely two electric motors, namely a first electric motor 14 and a second electric motor 15. The respective electric motor 14, 15 is designed, for example, as a brushless direct-current motor.

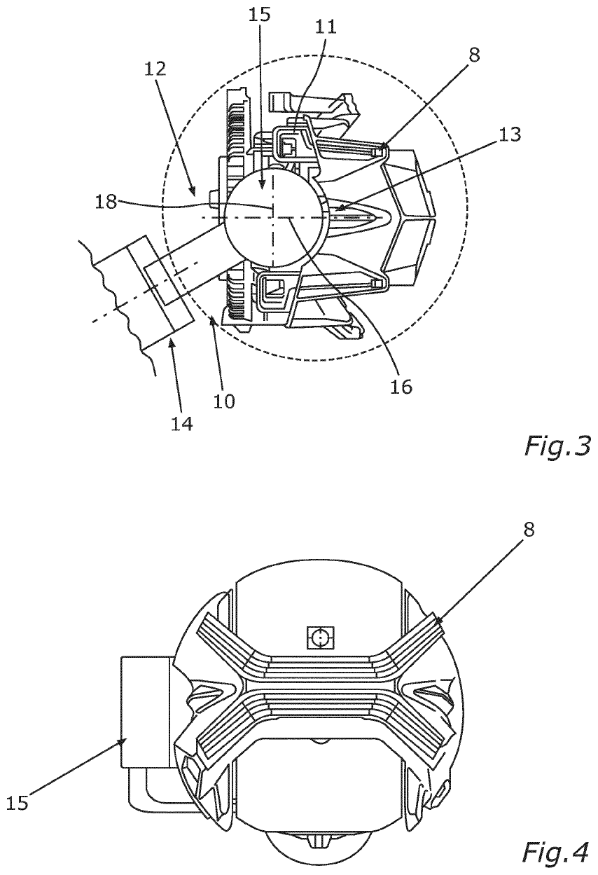

In order to be able to ensure particularly safe and therefore advantageous operation of the motorcycle 1, the drive device 13 is designed to provide a force and/or a respective torque, in particular acting around the respective pivot axis, and to exert it on the gimbal mount 12, in order to thus counteract the respective pivot movement, extending around the respective pivot axis, of the headlight 8, for example designed as a front headlight, and thus to decelerate the respective pivot movement. The first pivot axis can be seen in FIG. 3 and is referred to with 16. The second pivot axis can be seen in FIG. 2 and is referred to with 17, and the third pivot axis can be seen in FIG. 3 and is referred to with 18.

FIGS. 1 and 2 show the chassis 3 and the front headlight (headlight 8) in a respective starting orientation. The starting orientation of the headlight 8 is also shown in FIGS. 2 and 3.

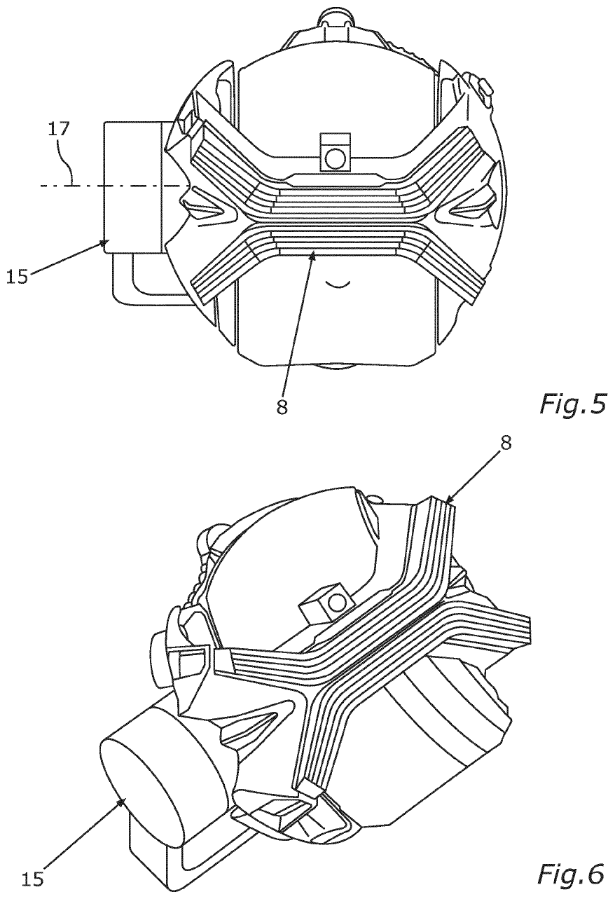

If the motorcycle 1 is, for example, driven along the above-mentioned ground and decelerated in this case, the chassis 3 thus executes a pitching movement around the vehicle transverse direction, as a result of which the headlight 8 is pivoted relative to the chassis 3 around the pivot axis 17, in order to thus, as can be seen in FIG. 4, hold the headlight 8 in the starting orientation of the headlight 8, while the chassis 3 is moved out of the starting orientation of the chassis 3 due to the pitching movement, however. FIG. 4 therefore shows the headlight 8 at a time of the pitching movement of the chassis 3. It can be seen that the headlight 8 is located in its starting orientation in spite of the pitching movement of the chassis 3.

If, for example, the motorcycle 1 is driven along the ground and accelerated in this case, the chassis 3 thus executes a second pitching movement around the vehicle transverse direction. FIG. 5 shows the headlight 8 at a time of the second pitching movement. The headlight 8 also remains in the starting orientation of the headlight 8 during and in spite of the pitching movement due to the gimbal mount 12. During the respective pitching movement, overshooting of the headlight 8 is prevented by way of the drive device 13, in particular by way of the electric motor 15, since the electric motor 15 counteracts the pivot movement of the headlight 8 extending around the pivot axis 17.

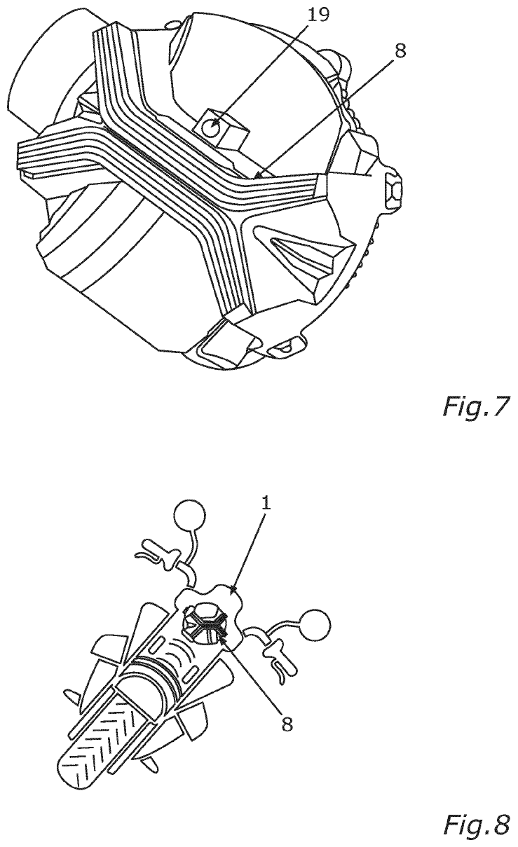

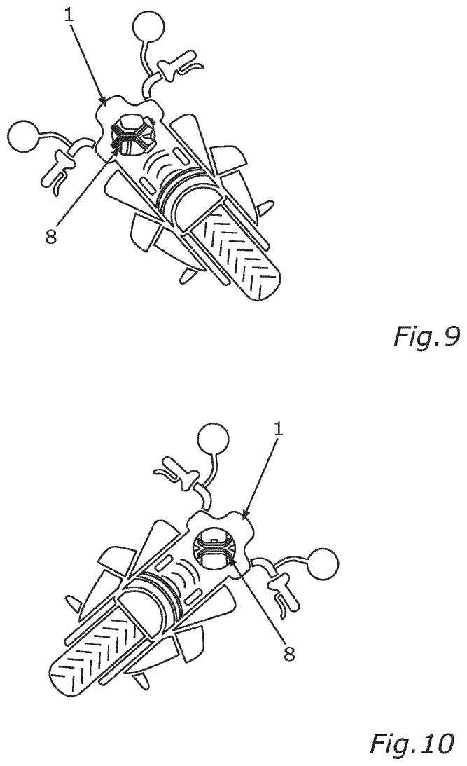

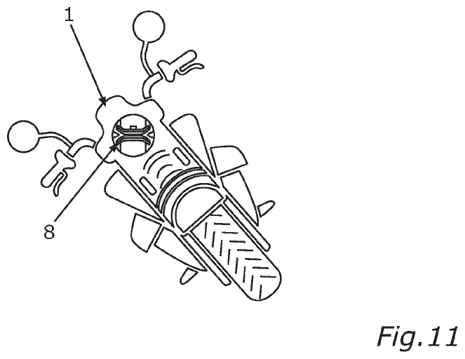

FIG. 6 shows, for example, the headlight 8 at a time of a first yawing and rolling movement of the chassis 3, and FIG. 7 shows, for example, the headlight 8 at a time of a second yawing and rolling movement of the chassis 3. For example, FIG. 8 shows the first yawing and rolling movement of the chassis 3, and FIG. 9 shows the second yawing and rolling movement of the chassis 3. Due to the gimbal mount 12, and in that the drive device 13, in particular the electric motor 14, counteracts the respective pivot movement of the headlight 8 extending around the respective pivot axis during the respective yawing and rolling movement, the headlight 8 remains in the starting orientation of the headlight 8 in spite of and during the respective yawing and rolling movement of the chassis 3, so that particularly advantageous illumination of the surroundings 9 can be ensured.

FIG. 9 shows a first rolling movement of the chassis 3. FIG. 10 shows a second rolling movement of the chassis 3. It can be seen that the first and second rolling movement can also be compensated for by way of the gimbal mount 12 and by way of the drive device 13, such that the headlight 8 does not also execute the respective rolling movement of the chassis 3, but rather remains in its starting orientation, in particular remains aligned or leveled in its center of gravity.

It can be seen from FIGS. 2 and 4 that the motorcycle 1, for example, has a surroundings camera 19, also referred to simply as a camera, which is held on the headlight 8 and is therefore held on the gimbal mount 12 via the headlight 8. The surroundings camera 19 is thus also pivotable with the headlight 8 around the pivot axes 16, 17, and 18 relative to the chassis 3, so that the surroundings camera 19 also remains in its starting orientation in spite of and during yawing and/or rolling and/or pitching movements of the chassis 3. The surroundings 9, i.e. at least an area of the surroundings 9, can thus particularly advantageously always be acquired by way of the surroundings camera 19.

### LIST OF REFERENCE SIGNS

1 motorcycle
2 vehicle wheel
3 chassis
4 double arrow
5 double arrow
6 handlebars
7 double arrow
8 headlight
9 surroundings
10 holding device
11 headlight housing
12 gimbal mount
13 drive device
14 first electric motor
15 second electric motor
16 pivot axis
17 pivot axis
18 pivot axis
19 surroundings camera

1-10. (canceled)

11. A motorcycle, comprising:
at least one headlight to illuminate at least a section of the surroundings of the motorcycle, and which is held on a chassis of the motorcycle via a gimbal mount of a holding device,
wherein the holding device has a drive device and the gimbal mount to permit pivot movements of the headlight taking place around at least two pivot axes extending perpendicularly to one another and relative to the chassis,
wherein the drive device provides a force and/or a torque to exert it on the gimbal mount, in order to thus counteract the respective pivot movement extending around the respective pivot axis and thus to decelerate the respective pivot movement.

12. A motorcycle, comprising:
at least one headlight to illuminate at least a section of the surroundings of the motorcycle, and which is held on a chassis of the motorcycle via a gimbal mount of a holding device,
wherein the holding device has a drive device and the gimbal mount to permit pivot movements of the headlight taking place around at least two pivot axes extending perpendicularly to one another and relative to the chassis,
wherein at least one surroundings camera, which acquires at least an area of the surroundings, is held on the chassis via the gimbal mount, and is thus also pivotable around the pivot axes relative to the chassis with the headlight.

13. The motorcycle according to claim 12, wherein
the drive device provides a force and/or a torque to exert it on the gimbal mount, in order to thus counteract the respective pivot movement extending around the respective pivot axis and thus to decelerate the respective pivot movement.

14. The motorcycle according to claim 12, wherein
the surroundings camera is held on the headlight and is thus held on the gimbal mount via the headlight.

15. The motorcycle according to claim 12, wherein
the gimbal mount permits pivot movements of the headlight taking place around a third pivot axis extending perpendicularly to the pivot axes and relative to the chassis.

16. The motorcycle according to claim 15, wherein
the drive device counteracts the respective pivot movement extending around the third pivot axis by exerting the force and/or the torque on the gimbal mount and thus to decelerate the respective pivot movement extending around the third pivot axis.

17. The motorcycle according to claim 12, wherein
the headlight is a front headlight.

18. The motorcycle according to claim 12, wherein
the motorcycle is a single-track vehicle having precisely two vehicle wheels.

19. The motorcycle according to claim 12, wherein
the motorcycle is a three-wheeled vehicle having precisely three vehicle wheels.

20. A method for operating a holding device of a motorcycle, wherein the motorcycle has at least one headlight to illuminate at least a section of the surroundings of the motorcycle, and which is held on a chassis of the motorcycle via a gimbal mount of the holding device, wherein the holding device has a drive device and the gimbal mount to permit pivot movements of the headlight taking place around at least two pivot axes extending perpendicularly to one another and relative to the chassis, the method comprising: providing and exerting a force and/or a torque on the gimbal mount by the drive device, by which the respective pivot movement extending around the respective pivot axis is counteracted and thus the respective pivot movement is decelerated.
